(19) United States
(12) Patent Application Publication
(10) Pub. No.: US 2016/0263584 A1
(43) Pub. Date: Sep. 15, 2016

(54) DEVICE FOR AGGREGATE PROCESSING

(71) Applicants: Murray J. Moran, Biloxi, MS (US); Murray L. Moran, Biloxi, MS (US)

(72) Inventors: Murray J. Moran, Biloxi, MS (US); Murray L. Moran, Biloxi, MS (US)

(21) Appl. No.: 14/645,895

(22) Filed: Mar. 12, 2015

(51) Int. Cl. B03B 5/68; B24B 31/10; B03B 7/00

(52) U.S. Cl. CPC B03B 5/68; B03B 7/00; B24B 31/10

(57) ABSTRACT

The present invention relates to a device for processing an aggregate material, the device comprising a hopper to receive an aggregate material and a conveyor tube with a proximal end adapted to receive the aggregate material from a hopper. The conveyor tube is further connected to multiple induction jets supplying pressurized water received from a water pump to form a slurry mix of aggregate material. A plurality of wear plates mounted on an inner surface of the conveyor tube, to allow the slurry mix to travel cylindrically around and down the tube towards a discharge outlet at a distal end of the conveyor tube.

### FIELD OF THE INVENTION

The present invention generally relates to a processing of aggregate particles and more specifically relates to a device for cleaning, separating and polishing of natural aggregate primarily comprising stone, sand and gravel.

### BACKGROUND OF THE INVENTION

Aggregates are granular materials, either naturally obtained or manufactured, constitutes an important component of infrastructure. Natural aggregate resources primarily comprise of sand, gravel and crushed stone. Secondary aggregates comprises by products from industrial process like blast, electric furnace slags or china clay residues. Development and extraction of natural aggregates are significantly influenced by constraints such as urbanization, zonal regulations, increased costs and environmental concerns.

Natural aggregates consists of rock fragments that are used in their natural state, or are used after mechanical processing such as crushing, washing, and sizing. Crushed stone and sand, and gravel are the two primary sources of natural aggregate, which are used directly in construction or as a raw material for construction products such as concrete and bituminous road materials.

The process of mining aggregate materials involves a rough and abrasive process that has been around for hundreds of years. Whether the reclamation of aggregate material is carried out via a dry mining process or a wet mining process, there still exists a need to separate dust, silt, clay or finely divided organic and inorganic material from the aggregate material. In addition, for certain applications, rounding or smoothing of the aggregate material edges is desired for providing aggregate material with uniform particulate size.

From the prior art, there exists numerous patents relating to aggregate processing apparatus and methods. For example: US patent publication 20120068381 shows a mobile factory for stone making and concrete processing from natural aggregates. US patent publication 20140044967 shows a system for processing and producing an aggregate. U.S. Pat. No. 7,380,674 discloses a method of processing and sorting aggregate material using a processing device. U.S. Pat. No. 2,146,405 shows an aggregate processing apparatus. However, existing aggregate processing devices also comprises limitations including infrastructure, apparatus size, operational complexity, inner plate wearing, complex machinery and the like.

Accordingly, there exists a need for an improved device for efficient separation of aggregate material from dust, silt, clay and other unwanted materials and also polishing or smoothing the aggregate material surface to achieve a uniform particle size.

### SUMMARY OF THE INVENTION

The present invention relates to a device for processing an aggregate material, the device comprising: a gravity feed hopper to receive an aggregate material and a conveyor tube with a proximal end adapted to receive the aggregate material from the hopper. The conveyor tube further connected to multiple induction jets to receive a supply of pressurized water from a water pump to form a slurry mix of aggregate material and a plurality of wear plates mounted on an inner surface of the conveyor tube, to allow the slurry mix to travel cylindrically around and down the tube towards a discharge outlet at a distal end of the conveyor tube.

### BRIEF DESCRIPTION OF DRAWINGS

FIG. 1 is a side view of a device for processing a natural aggregate material with a conveyor tube connected to multiple induction jets from below, according to an embodiment of the invention.

FIG. 2 is a side view of a device for processing a natural aggregate material with the conveyor tube connected to multiple induction jets from above, according to an embodiment of the invention.

FIG. 3 is a cut away view of the device showing arrangement of wear plates.

FIG. 4 is a sectional view of the device showing wear plates mounted to the conveyor tube.

FIG. 5 is a side view of the device comprising removable wear plates according to an embodiment of the invention.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

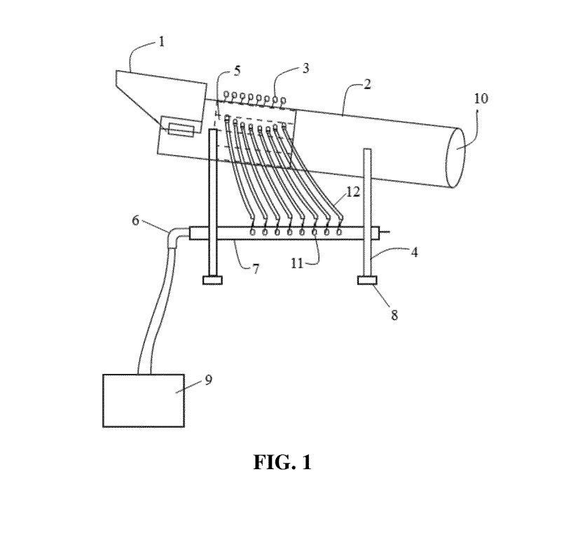

Referring to FIG. 1, which shows a side view of the device for aggregate material processing, the device comprises a gravity feed hopper 1 for receiving an aggregate material and a conveyor tube 2, with its proximal end connected to the outlet of the hopper 1 and distal end comprising a discharge outlet 10. The conveyor tube 2 further comprises a plurality of induction jets 3 configured to supply pressurized water received from a water pump 9 and a plurality of wear plates 5 mounted onto the inner surface of the conveyor tube 2. The device further comprises a water manifold 7 connected to the water pump via a manifold elbow 6. The water manifold consists a plurality of pressure gauges 11, in fluid connection with the induction jets 3 via water induction hoses 12.

The device can be mounted firmly on a stand comprising a plurality of legs 4 and a base support 8 connecting at least two legs 4 parallel to each other. In an embodiment, the induction jets 3 are serially distributed from below the conveyor tube 2 in order to supply pressurized stream of water into the conveyor tube 2 to form a slurry mixture of water and aggregate material. The wear plates 5 can be removable attached to the inner surface of the conveyor tube and can be replaced whenever needed.

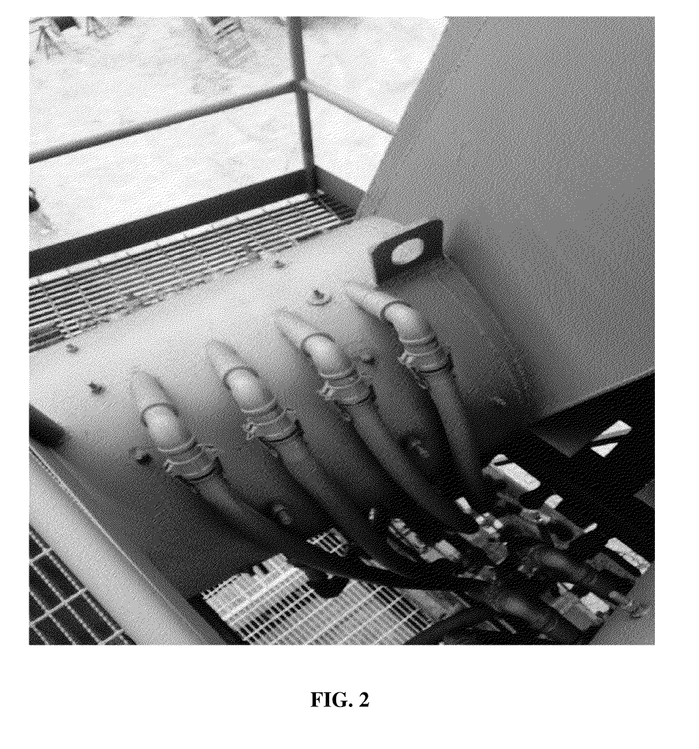

FIG. 2 shows a side view of the device for aggregate material processing as described above. In an embodiment, the figure depicts that the induction jets 3 are serially distributed from above the conveyor tube 2 in order to supply pressurized stream of water into the conveyor tube 2 to form a slurry mixture of water and aggregate material.

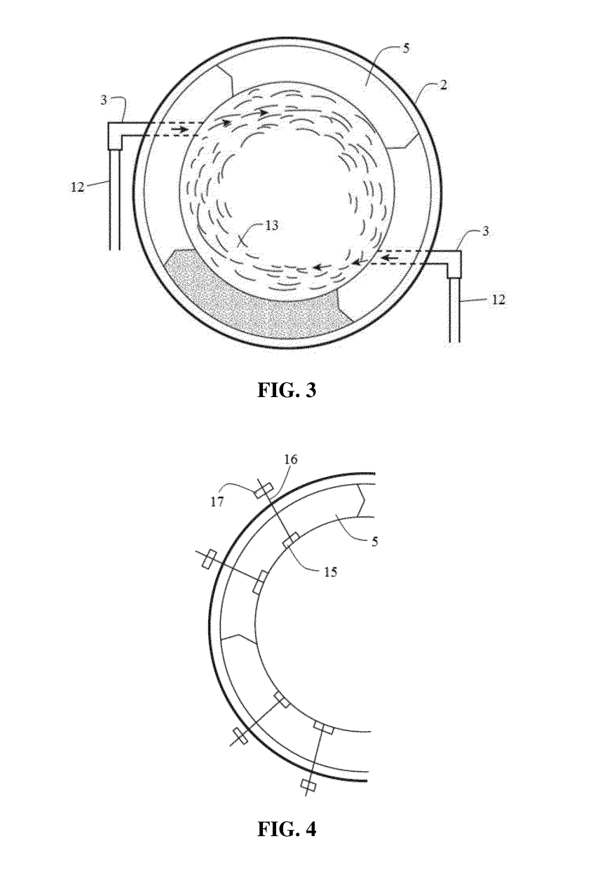

FIG. 3 is a cut away view of the device for aggregate material processing. The figure, illustrates the arrangement of wear plates 5 according to an embodiment of the invention. The water induction hoses 12 are configured to deliver water to the induction jets 3, at a preset volume and pressure, in order to mix the aggregate material and water into a slurry 13, the mixture is moved cylindrically within the tube due to water pressure and moved further down the tube due to gravity and processed aggregate is discharged via the outlet at the distal end of the conveyor tube.

The wear plates 5 may further comprise channels which connect the induction jets 3 to inner area of conveyor tube 2. The wear plates 5 may also be configured to fit together in an overlapped fashion forming a smooth surface for the slurry mix to travel around, which leads to polishing or smoothing of the surface texture resulting in processed aggregate with uniform particle size or desired particle size.

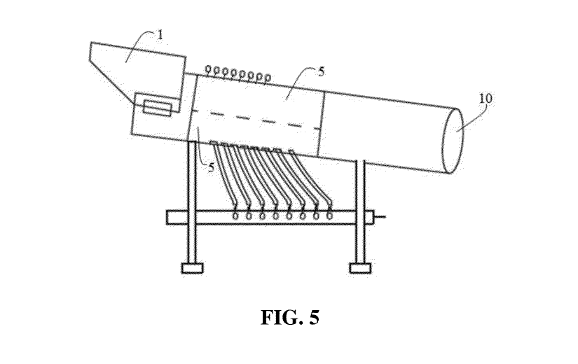

In an embodiment, the wear plates are mounted onto the inner surface of the conveyor tube via a bolting or a similar means of attachment. FIG. 4 is a cross sectional view of the device showing wear plates mounted on the inner surface of the conveyor tube. In an embodiment, the wear plates 5 may comprise recessed cavities 15 to receive a bolt 16 which is driven through preformed holes or channels in the wear plate 5 connecting within the conveyor tube, and fastened with a fastener 17 on the external surface of the conveyor tube. Thus, the wear plates are securely attached to the inner circumference of the conveyor tube without the bolt's head structure interfering with the smoothness of tube inner surface.

The wear plate may also comprise a bolt mold or a counter bore to receive the bolt structure so as to form a smooth continuous surface on the inner circumference of the conveyor tube, thereby prevent wearing of the exposed bolt head.

FIG. 5 shows a side view of the device comprising removable wear plates according to an embodiment of the invention. The removable wear plates 5 can be located on the inner surface of the conveyor tube adjacent to the proximal end, towards the hopper 1. In a different embodiment, the removable wear plates 5 can be located on the inner surface of the conveyor tube adjacent to the distal end, towards the outlet 10. The material, position and surface texture of the wear plate can be chosen according to the aggregate material to be processed.

In an exemplary embodiment, the aggregate material is introduced into the hopper and the aggregate is delivered to the conveyor tube via gravity. The aggregate is mixed with water at high pressure and volume, received via induction jet from the water pump, to create a slurry. The slurry of water and aggregate travel by tumbling cylindrically against the wear plates inside the conveyor tube and pass through the length of the tube to exit at the outlet due to gravity. The finish of processed aggregate material can be customized using the variables including alloy material, thickness and travel length of the wear plates, slanting angle of the conveyor tube, volume and pressure of induction jets.

The device of the present invention can be constructed with any suitable material. By way of non-limiting example, the parts of the device can be manufactured using a variety of standard steel alloys which are able to withstand stress and dynamic load associated with the present invention. The water pump and water induction hoses can be selected based on the desired volume and pressure of water to be introduced into the conveyor tube. Similarly, the pressure gauges can be selected based on the hydraulic pressure deployed through the water manifold and induction hoses. The wear plates can be constructed from a material that allows for surface molding of wear plates to create a riffling or tumbling effect on the slurry mix.

Advantages of the present invention includes but not limited to, polishing or smoothing a variety of different aggregate materials in a larger volume and separation of clay, dust and silt from the targeted aggregate material.

The present invention has been described with a preferred embodiment thereof and it is understood that many changes and modifications to the described embodiment can be carried out without departing from the scope and the spirit of the invention that is intended to be limited only by the appended claims.

1. A device for processing an aggregate material, the device comprising:
a) a conveyor tube with a proximal end adapted to receive an aggregate material from a hopper;
b) a plurality of induction jets connected to the conveyor tube, to supply pressurized water received from a water pump to form a slurry mix of aggregate material; and
c) a plurality of wear plates mounted on an inner surface of the conveyor tube, to allow the slurry mix to travel cylindrically around and down the conveyor tube towards a discharge outlet; and
wherein the plurality of wear plates are overlapped with each other.

2. The device of claim 1, further comprises a water manifold comprising a plurality of pressure gauges in fluid connection with the induction jets.

3. The device of claim 1, wherein the hopper comprises a gravity fed hopper.

4. The device of claim 1, wherein the conveyor tube is at an oblique angle allowing gravity movement of the slurry mix through the conveyor tube.

5. The device of claim 1, wherein the discharge outlet is present at the distal end of the conveyor tube.

6. The device of claim 1, wherein the wear plates are removable and replaceable.

7. (canceled)

8. The device of claim 1, wherein the conveyor tube is connected to a plurality of induction jets from above.

9. The device of claim 1, wherein the conveyor tube is connected to a plurality of induction jets from below.

10. The device of claim 1, wherein the pressure gauges are connected to induction jets via water induction hoses.
